(19) United States
(12) Patent Application Publication
(10) Pub. No.: US 2008/0082492 A1
(43) Pub. Date: Apr. 3, 2008

(54) Data Processing System and Method for Computer Assisted Learning

(75) Inventor: Frank Gotthardt, Eitelborn (DE)

Correspondence Address: KAPLAN GILMAN GIBSON & DERNIER L.L.P., 900 ROUTE 9 NORTH, WOODBRIDGE, NJ, 07095, US

(73) Assignee: CompuGroup Holding AG, Koblenz (DE)

(21) Appl. No.: 11/536,949

(22) Filed: Sep. 29, 2006

(51) Int. Cl. G06F 19/00

(52) U.S. Cl. 707/3

(57) ABSTRACT

A data processing system includes: means for accessing a medical case database; means for entering case-related data in the case database; means for accessing a medical specialty questions database; means for generating a query for the specialty questions database with the help of the case-related data; means for displaying a specialty question obtained by the query; means for entering an answer to the specialty question; and means for evaluating an answer.

### BACKGROUND

The invention relates to a data processing system, a method for computer-assisted learning as well as a corresponding computer program product.

From the state of the art, various computer-based learning and teaching methods are known. U.S. Pat. No. 5,441,415 discloses a method of this type, in which the efficiency of individual learning is supposed to be improved by monitoring the learning progress in that the course material is paced to the abilities of the student. For this, interactive multimedia technology is combined with courseware development in order to provide a flexible teaching tool.

Another computer-based learning system is known from DE 697 17 659 T2, which analyzes test results in an effort to identify corresponding skills gaps and based thereon create a personalized syllabus.

Continuous on-the-job training and continuing education are gaining increasing importance in various fields. Particularly in the medical profession, continuing medical education (CME) is an indispensable part of the professional core values and as such is included even in the Model Professional Code of Conduct of the Federal German Medical Profession. With the Health System Modernization Act (GMG), which took effect on Jan. 1, 2004, the continuing education of employees in the medical field, which used to be voluntary in the German Federal Republic, has become mandatory. For physicians in private practices it is provided that they must offer proof to the Medical Insurance Association every five years of having complied with their continuing education obligation over the preceding five-year period. If this proof of continuing education is not provided, or not fully provided, sanctions are imposed ranging from cuts in fees to the petition for revocation of the authorization to practice medicine.

A corresponding continuing education obligation also exists for specialty physicians working in hospitals. There, a committee is commissioned with taking quality assurance measures in the hospitals, including those of a continuing education obligation that the specialty physician must comply with in five-year intervals. Hospitals, which are not able to prove that their physicians complied with this continuing education obligation, run the risk of losing their care provision agreements.

The medical associations issue a continuing education certificate if within a period of three years 150 continuing education credits have been acquired and documented. One continuing education credit generally corresponds to one academic hour and can be acquired through events certified by the regional medical association. The continuing education certificate offers proof of the statutory continuing education.

One problem associated with continuing education events of this type is that they cannot be targeted to individual skill gaps and the respective concrete fields of the physicians and therefore are relatively inefficient.

### SUMMARY OF THE INVENTION

It is therefore the object of the invention to create a data processing system, a method for computer-assisted learning as well as a corresponding computer program product, which is suited for on-the-job continuing education in the medical field.

The invention provides a data processing system with means for accessing a medical case database, means for entering case-related data in the case database, means for accessing a medical specialty questions database, means for generating a query for the specialty questions database with the help of the case-related data, means for releasing a specialty question obtained through a query, means for entering an answer to the specialty questions and means for evaluating the answer.

According to the invention, therefore, the case-related data, which a physician enters, for example, during or following the treatment of a patient, is used for selecting a specialty question from a specialty questions database. This offers the advantage that the treating physician is faced with specialty questions that relate to the medical cases he treats and/or that are relevant for the medical field he covers.

In addition to specialty questions, the specialty questions database may also be used to store continuing education units. Each continuing education unit is then typically associated with several specialty questions. According to one embodiment of the invention, the physician must first process the continuing education unit that is associated with a specialty question before the data processing system will release the specialty question to the physician for answering. The continuing education unit can include, for example, text and/or multimedia and/or interactive training materials for the continuing education of physicians.

According to one embodiment of the invention, the case-related data is encoded. The case-related data can be, for example, diagnostic data and/or service data for service tracking and billing to the health insurance companies. Every possible diagnosis and/or every possible service that a physician may provide is associated with a unique code. The diagnosis and/or the service are entered by storing the corresponding code.

Every specialty question that is stored in the specialty questions database is associated with at least one of these codes. This code association is used to associate the specialty question with the diagnosis and/or service associated with the code. The search for specialty questions in the specialty questions database can then be carried out such that following the input of the encoded diagnosis and/or service, the code associated with the diagnosis and/or service is used as a search criterion for a query of the specialty questions database. As a result, specialty questions are determined, which are relevant for the previously recorded diagnosis and/or service.

The release of a specialty question selected with the help of the case-related data can occur, for example, directly after the case-related data has been entered. For example, the physician can answer this specialty question between two patient appointments. Consequently, the continuing education of physicians becomes an integral part of the process of the practice or clinic.

Alternatively, however, the selected specialty questions can also be stored for answering later on. For example, the specialty questions can be exported via an interface to a portable electronic device, for example to a Personal Digital Assistant (PDA), a smart phone, a mobile phone, particularly a UMTS phone, a laptop or the like, so that the physician can process these specialty questions for example in the evening or on the weekend outside of work. Alternatively or additionally, the specialty questions are stored on an Internet portal and associated there with the respective physician. When the physician logs in, he is granted access to the specialty questions stored for him to process and can download them and then process them locally or process the questions directly via the Internet browser.

According to one embodiment of the invention, the data processing system is integrated in the practice IT system of a physician's practice or in an electronic management system of a hospital. The data of each patient is captured in a virtual file card. On the occasion of a patient consultation and/or a physician's ward round, the virtual file card of the patient is opened, allowing the additional case-related data of the patient gained from the consultation and/or the ward round to be entered in the virtual file card. This data includes, for example, anamnesis, diagnostic, therapeutic and/or prescription data.

According to one embodiment of the invention, a query of the specialty questions database is carried out after closing the virtual file card, meaning after storing the supplemental case-related data, wherein one or more case-related pieces of data stored in the virtual file card are used as search terms for searching for a suitable specialty question.

According to one embodiment of the invention, the service tracking function initiates a query in the specialty questions database. During service tracking, codes associated with the individual physician services are stored. These codes are used as search criteria for the query of the specialty questions database.

According to one embodiment of the invention, every specialty question in the specialty questions database is associated with a clear identification. If the treating physician prefers not to respond to the specialty question right away, but rather at a later time, the corresponding specialty question identification is stored separately. As a result, a list of specialty question identifications is created, which the physician must process either at regular or irregular intervals.

According to one embodiment of the invention, the specialty questions database includes for each specialty question a reference to a file with a learning module, which relates to the subject of the specialty question. If a specialty question is answered incorrectly, the treating physician is offered the appropriate learning module for immediate review or for review later on.

The specialty questions can also be broken down into different categories. Each category of specialty questions is then associated with one or more learning modules. When the physician in a certain category does not achieve a certain minimum percentage of correctly answered questions, he will be offered one or more of these learning modules associated with the respective category of specialty questions for immediate review or for review later on.

In another aspect, the invention relates to a method for computer-assisted learning. The method comprises the following steps: entering of case-related data in a case database, use of one or several case-related pieces of data for querying a specialty questions database, releasing the specialty question obtained from the query of the specialty questions database, and evaluating a response entered for the specialty question.

In another aspect, the invention relates to a computer program product, particularly a digital storage medium, for implementing such a method. A corresponding computer program can be implemented, for example, on a personal computer or a portable electronic device. It can also be implemented in a network environment, such as a client-server architecture for example. Furthermore, it is also possible to implement it as a distributed data processing system, for example including public networks, such as the Internet. The specialty questions database and/or the learning modules can be made available via one or more web services, for example.

Furthermore it is possible to link medical devices to the inventive data processing system. The case-related data supplied by medical devices of this type can be included in the selection of the specialty questions.

Other aspects, features, and advantages of the present invention will be apparent to one skilled in the art from the description herein taken in conjunction with the accompanying drawings.

### BRIEF DESCRIPTION OF THE DRAWINGS

Exemplary embodiments of the invention will be explained hereinafter in more detail with reference to the drawings. Shown are:

FIG. 1: a block diagram of a first embodiment of a data processing system according to the invention,

FIG. 2: a flow chart of one embodiment of a method according to the invention,

FIG. 3: a virtual patient file card for entering case-related data,

FIG. 4: a window of a graphic user interface for releasing a case-related question and for entering an answer to the multiple-choice question, and

FIG. 5: a flow chart of another embodiment of a method according to the invention.

### DETAILED DESCRIPTION OF THE INVENTION

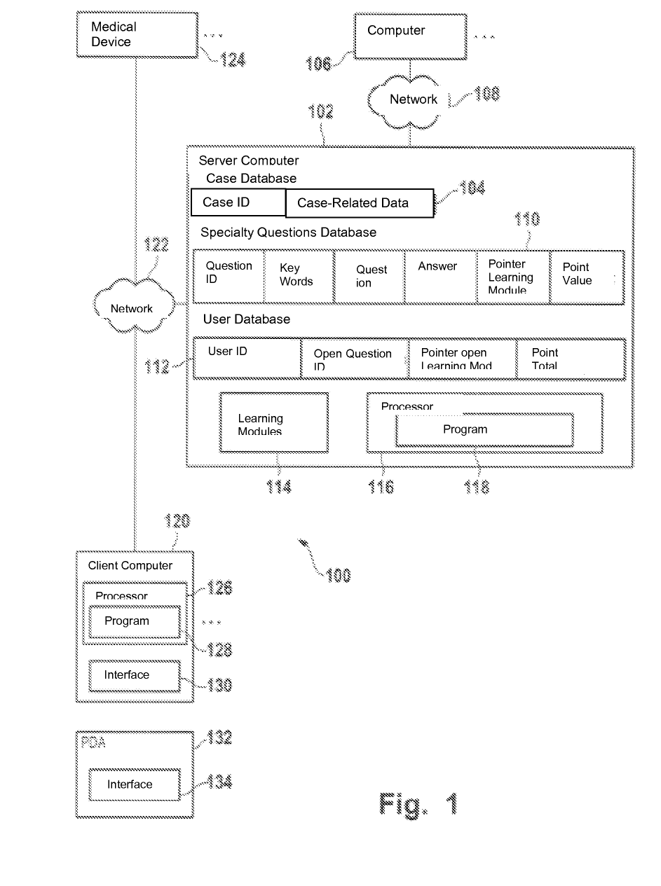

FIG. 1 shows a data processing system 100 with a server computer 102. In the server computer 102 a case database 104 is stored. The case database 104 comprises case-related data for every stored medical case and a unique identification for the respective medical case, referred to as the case ID. A medical case here is, for example, a sequence of connected medical measures within the framework of the outpatient and/or inpatient care of a patient, the virtual file card of a patient with the medical data and/or the complete electronic patient file.

Instead of on the server computer 102, the case database 104 can also be stored entirely or partially on one or more external computers 106, which the server computer 102 can access via the network 108, for example the Internet.

Furthermore, a specialty questions database 110 can be stored on the server computer 102. The specialty questions database contains various specialty questions and continuing education units that are associated with the specialty questions. The specialty questions can be categorized and/or indexed. The key words may optionally be stored in the specialty questions database 110 as search terms for selecting specialty questions. Alternatively or in addition to the indexing of specialty questions, the specialty questions may be associated with service and/or diagnostic codes. The database query can then be carried out with the help of a service and/or diagnostic code.

Each of the specialty questions is associated with a unique identification, meaning a question ID. When using a multiple-choice method, several answers are stored for each specialty question, of which answers one or more are correct. Furthermore, each specialty question is associated with a point value, which is awarded to the processing person when the question is answered correctly. Furthermore, each specialty question is associated with a pointer for a learning module containing material relating to the subject of the specialty question.

The specialty questions database 110 can also be stored entirely or partially on one of the external computers 106.

Furthermore, a user database 112 can be stored on the server computer 102. The user database 112 comprises a clear identification for each registered user, meaning a user ID. Every user ID can be associated with one or more question IDs, which identify open specialty questions of the specialty questions database 110 that the respective user still has to process. Furthermore, each user ID can be associated with one or more pointers for learning modules, which the respective user still has to process. Furthermore, every user ID can be associated with a cumulative point value, which was awarded based on correct answers to specialty questions and/or the processing of learning modules. Also the user database 112 can be stored entirely or partially on one of the computers 106.

The same applies for the learning modules that can be stored locally in a memory 114 of the server computer 112 or entirely or partially on one of the external computers 106. The learning modules can be text documents or multimedia and/or interactive materials.

Furthermore, the server computer 102 comprises at least one processor 116 for executing a program 118.

A client computer 120 can be connected to the server computer 102 via a network 122, for example an Ethernet. One or more medical devices 124 can also be connected via the same network 122 to the server computer 102 and/or the client computer 120. Typically several client computers 120 for the various workstations, for example of a joint practice, a hospital or another medical facility, can be connected via the network 122 to the server computer 102 and/or at least one medical device 124.

The server computer 120 comprises at least one processor 126 for executing a program 128. The client computer 120 may furthermore comprise an interface 130 for exchanging data with a portable electronic device, for example a PDA 132, which is provided with an appropriate interface 134. The interfaces 130, 134 can be configured for conventional or wireless communication. The interfaces 130, 134 can be Bluetooth interfaces or the like, for example.

During operation, the user of the client computer 120 initially logs in with the user ID as the identification. The user can be, for example, the treating physician of a patient.

On the occasion of a patient's treatment appointment, the treating physician opens the virtual patient file card containing the corresponding case-related data from the case database 104 of the patient by entering the patient identification, meaning the case ID. Then, the physician may store additional case-related patient data gained during the treatment appointment by means of the program 128 by manually entering it in the case database 104 and/or he may load the supplemental case-related data via the network 122 into the case database 104 by directly transmitting it from the medical device 124. The medical device 124 can be, for example, an imaging device, which produces DICOM files, containing text information in addition to the image data. During or following the treatment appointment, the medical services provided by the physician are recorded by entering one or more corresponding service codes.

The program 118 uses the case-related data received from the client computer 120 and/or the case-related data received from the medical device 124 and/or the case-related data previously stored in the case database 104 for the respective patient and/or the service codes entered within the framework of service tracking in order to generate a search query for the specialty questions database 110. For this, the program 118 may select one or more case-related pieces of data randomly or based on predefined rules in order to search the questions that are stored in the specialty questions database 110 or to search the key words of the specialty questions. This search can be implemented as a search in structured data sets or as a search in non-structured data sort of like a search engine. The search for suitable specialty questions can also occur exclusively with the help of the service codes.

The network 122 transmits a specialty question obtained by the program 118 from the specialty questions database 110 based on the search query to the client computer 120, where the program 128 displays this question. Furthermore, also the multiple-choice answers associated with the specialty question are displayed.

The treating physician is then able to respond directly to the question. If the question is answered correctly, the point value stored for the physician in the user database 112 is increased by the point value associated with the question that is stored in the specialty questions database 110. However, if the question is answered incorrectly, the treating physician may be offered a learning module, specifically for immediate processing or for processing later on. If the physician opts to process the question later, a pointer for the learning module to be processed is stored in the user database 112 of the treating physician. The treating physician may also opt to answer the specialty question not directly following the treatment appointment, but at a later time. In this case, the question ID of the specialty question to be answered is stored in the user database 112 of the respective physician.

Alternatively, it is also possible to configure the data processing system 100 such that the physician first has to process a continuing education unit, which is associated with the specialty question determined by the query of the specialty questions database 110, before the data processing system 100 releases the specialty question to the physician for answering.

For example, at the end of a workday or before the weekend the treating physician can synchronize his PDA 132 with the entries stored for him in the user database 112 via the interfaces 130, 134. The specialty questions identified as a result of the open question IDs in the user database 112 and their multiple choice answers, for example, and/or the learning modules identified in the user database 112 by the pointers for the open learning modules, are transferred to the PDA 132. Alternatively, it is also possible to only store the open question IDs and/or the pointers for the opening learning modules on the PDA 132.

If the physician would like to process an open question or an open learning module at a later time, the PDA 132 transmits an HTTP command, for example to the server computer 102 or one of the computers 106, wherein the command comprises at least one question ID of an open question and/or a pointer, such as a URL, for an open learning module.

Thereafter, the requested data is transmitted to the PDA 132, so that the physician can process the open question and/or the open learning module. After the physician has returned to the workplace, another synchronization step with the PDA 132 can be carried out. The information as to which of the open questions have been answered correctly and which incorrectly and/or which open learning modules have been processed is transmitted via the interfaces 130, 134 from the PDA 132 to the client computer 120 and via the network 122 to the server computer 102. Based on this information, the user database 112 is updated, meaning the open question IDs of the questions that have been answered in the meantime and/or the pointers for the open learning modules that have been processed in the meantime are deleted and the cumulative point value is increased accordingly. If the physician has answered questions incorrectly, the corresponding pointers are added to the learning modules requiring processing.

The program 118 may have different operating modes, which the user can set from his client computer 120 as user settings with the help of the program 128. The user settings can be used, for example, to establish that a specialty question is determined and displayed for answering every time a virtual patient file card is closed. This means that, between two treatment appointments, the treating physician will be asked one or more specialty questions relating to the previous treatment appointment. Alternatively, via the user settings it may be defined that the specialty questions are not asked between the treatment appointments every time a virtual patient file card is closed, but rather that the open questions are first collected in the user database 112 so that the respective physician can process them at a later time. The same applies for the learning modules.

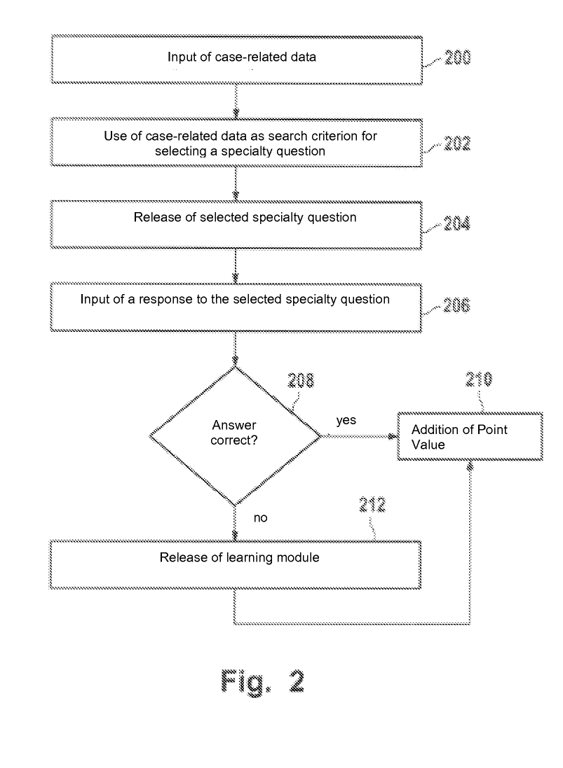

FIG. 2 shows a corresponding flow chart. In step 200, case-related data, for example that of a patient, is entered in a practice IT system and/or in an electronic management system of a hospital or another medical facility. Alternatively or additionally, the case-related data is entered directly by a medical device, which was used for examining the respective patient.

In step 202, the case-related data is used as a search criterion for selecting a specialty question from the specialty questions database. For example, the type of data provided by the medical device and/or the diagnostic and/or therapeutic information that was entered by the treating physician can serve as a search criterion.

In step 204, the specialty question that was determined based on the search is released from the specialty questions database and displayed for answering. In step 206, an answer is entered for the specialty question. This can occur, for example, with a multiple-choice method or by answering the specialty question in text form. The answer may be entered via the keyboard, a mouse click or voice input.

In step 208, the answer is evaluated and a decision is made as to whether the answer is correct or incorrect. If the answer is correct, in step 210 the point value stored for the respective user is increased by the point value associated with the specialty question in the specialty questions database. However, if the specialty question is answered incorrectly, in step 212 the learning module associated with the incorrectly answered specialty question is displayed and offered to the respective user for processing. Following processing of the learning module, the sequence control moves to step 210, where the point value is increased accordingly.

After reaching a predefined minimum point value of 150 continuing education credits, for example, a certificate may be printed automatically, serving as proof of having carried out the mandatory continuing education.

The certificate may be imprinted, for example, with the title of the successfully completed continuing education unit, a code identifying the continuing education unit, the point value that was achieved, the personal data of the physician having completed the continuing education unit and/or further information. The imprint may be done in plain text and/or in encoded, machine-readable form, for example in the form of barcodes and/or 2D barcodes.

The certificate may be printed locally as a preliminary certificate on the printer of the client computer 120. The preliminary certificate then has to be transmitted, for example electronically or by mail, to an authorized institute, for example a continuing education service provider, an authority, an insurance company or medical association. There, the certificate is recorded electronically and on the basis of the recorded data a final certificate will be issued, which will be forwarded to the physician. The data recorded by the institute may be forwarded electronically to other institutes for whom the data is relevant.

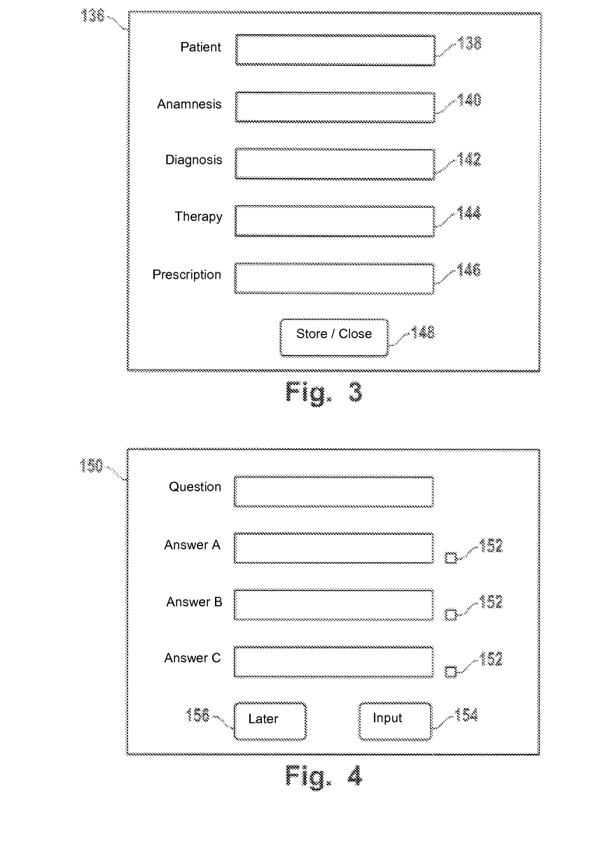

FIG. 3 shows an input window 136, as it may be used in the data processing system 100 for entering case-related data. The input window 136 comprises an input field 138 for entering of data identifying the patient, such as the patient name and/or the patient's case ID, meaning a patient identification, an input field 140 for entering anamnesis data, an input field 142 for entering diagnostic data, an input field 144 for entering therapeutic data and an input field 146 for entering prescription data. Alternatively or additionally, the input window 136 comprises an input field for entering a service code for recording the service provided by the physician. After the user has entered this case-related data in the input window 136, the session is terminated by clicking on the virtual control 148 of the input window 136, meaning the input window 136 is closed and the case-related data entered previously in the input window 136 is stored in the case database.

Thereafter, a specialty question is determined from the specialty questions database by means of a search query with the help of the previously entered specialty-related data. This question and the associated multiple-choice answers are displayed on an output window 150. In the exemplary case described here, the specialty question is associated with three possible answers A, B, C, which can be selected as the correct answers by clicking one or more check boxes 152. After selecting the correct answer or answers, the user can click on the virtual control 154, thus entering the answer to the specialty question in the data processing system. Alternatively, the user can click on the virtual control 156 in order to answer the posed specialty question at a later time.

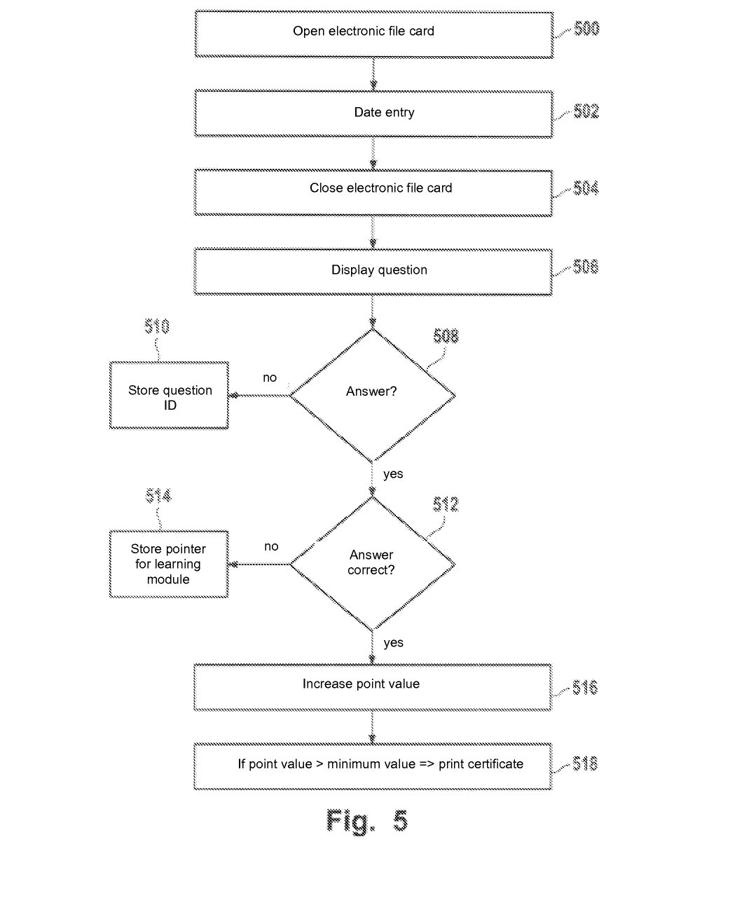

FIG. 5 shows another embodiment of the method according to the invention. In step 500, the electronic file card of a patient to be treated is opened. In step 502, supplemental case-related data obtained for example from the examination of the patient, such as diagnostic, therapeutic, prescription and/or billing data, for example service codes, is entered in the electronic file card. In step 504, the electronic file card is closed upon completion of the treatment appointment.

Thereafter, in step 506 a specialty question is displayed, which was selected based on the previously entered case-related data. In step 508, it is determined whether the user desires to answer the specialty question at that time or not. If the user desires to answer the question at a later time, the identification of the specialty question, meaning the question ID, is stored in step 510. However if the specialty question is answered, it is examined in step 512 whether the answer is correct. If this is not the case, in step 514 a pointer is stored for the learning module associated with the specialty question.

If the answer was correct, in step 516 the point value associated with the respective user is increased by the point value associated with the question. In step 518, a certificate is printed when the cumulative point value associated with the user has reached or exceeded a minimum value.

The question IDs and/or pointers for learning modules stored in steps 510 and 514 may be recalled at a later time, allowing the user to process the open questions and/or open learning modules for example in his spare time or on the weekend.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### REFERENCE NUMERAL LIST

100 Data Processing System
102 Server Computer
104 Case Database
106 Computer
108 Network
110 Specialty Questions Database
112 User Database
114 Memory
116 Processor
118 Program
120 Client Computer
122 Network
124 Medical Device
126 Processor
128 Program
130 Interface
132 PDA
134 Interface
136 Input Window
138 Input Field
140 Input Field
142 Input Field
144 Input Field
146 Input Field
148 Control
150 Output Window
152 Check Box
154 Control

1. A data processing system, comprising:
means for accessing a medical case database;
means for entering case-related data in the case database;
means for accessing a medical specialty questions database;
means for generating a query for the specialty questions database with the help of the case-related data;
means for displaying a specialty question obtained by the query;
means for entering an answer to the specialty question; and
means for evaluating an answer.

2. A data processing system according to claim 1, wherein the case database comprises a virtual file card for each patient to allow entry of case-related data of the respective patient.

3. A data processing system according to claim 2, wherein the query is generated after closing the virtual file card.

4. A data processing system according to claim 1, wherein:
the case-related data includes anamnesis data, data recorded by a medical device, diagnostic data, therapeutic data, prescription data, information for service tracking, and/or information for service codes; and
one or more of the case-related data are used for the query.

5. A data processing system according to claim 1, wherein the specialty questions database includes:
a specialty questions identification (ID), for each specialty question, as an access key; and
means for storing the specialty questions identification when no answer is entered after displaying the appropriate specialty question.

6. A data processing system according to claim 5, comprising an interface for a portable electronic device for transmitting the stored specialty questions identifications and/or the corresponding specialty questions to the portable device.

7. A data processing system according to claim 1, wherein the specialty questions database comprises a reference to a file with a learning module for each specialty question.

8. A method for computer-assisted learning, comprising:
entering case-related data in a case database;
using one or more case-related pieces of data for querying a specialty questions database;
releasing the specialty question obtained by querying the specialty questions database; and
evaluating an answer that was entered for a specialty question.

9. A method according to claim 8, wherein a file with learning modules is provided if the specialty question was answered incorrectly.

10. A digital storage medium containing a program having computer-executable instructions for causing a processor to perform actions, comprising:
entering case-related data in a case database;
using one or more case-related pieces of data for querying a specialty questions database;
releasing the specialty question obtained by querying the specialty questions database; and
evaluating an answer that was entered for a specialty question.
